(19) United States
(12) Patent Application Publication
(10) Pub. No.: US 2013/0181679 A1
(43) Pub. Date: Jul. 18, 2013

(54) PASSENGER BUS WITH ON-BOARD CHARGER

(71) Applicant: NEW FLYER INDUSTRIES CANADA ULC, Winnipeg (CA)

(72) Inventor: Glen David NAYLOR, Winnipeg (CA)

(73) Assignee: NEW FLYER INDUSTRIES CANADA ULC, Winnipeg (CA)

(21) Appl. No.: 13/669,788

(22) Filed: Nov. 6, 2012

Related U.S. Application Data
(60) Provisional application No. 61/586,188, filed on Jan. 13, 2012.

(51) Int. Cl. H02J 7/00

(52) U.S. Cl. 320/134

(57) ABSTRACT

The disclosure describes systems, devices and methods relating to the charging of electrical energy storage devices on passenger buses. The disclosure also describes a passenger bus (30) comprising: an electrical energy storage device (34) for supplying electrical power to an electrical load (36); an interface (40) for receiving electrical power from an off-board source (42); and an on-board charger (38) electrically coupled to the electrical energy storage device (34). The on-board charger (38) is configured to convert electrical power received from the off-board source (42) via the interface (40) to a form suitable for charging the energy storage device (34).

### CROSS REFERENCE TO RELATED APPLICATION AND CLAIM OF PRIORITY

The present application claims priority to U.S. provisional patent application No. 61/586,188 filed on Jan. 13, 2012, the entire contents of which are hereby incorporated by reference.

### TECHNICAL FIELD

The disclosure relates generally to passenger buses, and more particularly to charging of electrical energy storage devices on passenger buses.

### BACKGROUND

Passenger buses, including hybrid and all-electric buses, typically comprise one or more on-board batteries that store electrical energy used for powering electric loads on board the buses. In hybrid and other electric buses, such loads can include one or more traction motors used to propel the bus. As shown in FIG. 1, a bus 10 can include battery 12 that can be used to power electrical load 14 via power converter 16. Power converter 16 may be configured to perform the required power conversion based on the type of load 14 (e.g. AC or DC). The range and other operating parameters of an electric bus may be limited by the amount of energy (i.e. charge) available in battery 12. Accordingly, battery 12 may be rechargeable, and may periodically require charging to replenish its charge.

According to present methods, the charging of battery 12 requires that a driver of bus 10 take the bus to a specially-equipped charging station, comprising one or more special-purpose chargers 22, which act as electrical interfaces and connections between off-board power source(s) 20 (e.g., the electrical utility grid) and battery 12, and leave the bus connected to a charger 22 for a period of time sufficient to obtain a desired charge in battery 12. Because power from off-board power source 20 is typically in a form suitable for local or long-distance distribution (e.g. three-phase AC power), but not suitable for charging battery(ies) 12, chargers 22 are required in order to convert power from the utility power source 20 to a form more suitable for charging battery(ies) 12 (e.g. regulated DC power).

For passenger buses and other vehicles, off-board chargers 22 are special-purpose devices, which are typically expensive to purchase, and require significant amounts of station/depot/terminal floor space, as well as specialized maintenance and associated operational and maintenance training. Therefore typically a limited number of chargers can be purchased, and put to gainful use, with resulting limitations on the number of buses that can be charged at one time, and in the number of locations at which they can be charged, and significant increases in the number and size of terminals/stations/depots required for transit, charter, and other fleet operations, as well as operational expense and complexity.

In other words, the use of off-board chargers for passenger buses can have significant effects on the cost, size, flexibility, efficiency, and ease of providing transit and other fleet services.

Improvement in equipment and processes used in the charging of batteries on passenger buses is therefore desirable.

### SUMMARY

The disclosure describes systems, devices and methods relating to the charging of electrical energy storage devices on passenger buses.

In various aspects, for example, the disclosure provides passenger buses comprising electrical energy storage devices for supplying electrical power to on-board electrical loads, including as a particularly advantageous example traction motors; interfaces for receiving electrical power from off-board sources; and on-board chargers electrically coupled to the electrical energy storage devices, the on-board chargers being configured to convert electrical power received from the off-board sources via the interface to form(s) suitable for charging the energy storage devices.

On-board chargers suitable for use in implementing the invention can include any electrical and/or electro-mechanical device(s) suitable for converting power available off-board the bus into power suitable for charging the buses' electrical energy storage devices. For example, suitably-configured combinations of power converters, including bi-directional power converters, transformers, switches, and other circuit components may be used.

In further aspects, the disclosure provides electrical systems and components for such buses.

In further aspects, the disclosure provides methods and systems for operating, maintaining, and maintaining or refreshing electrical charges on such buses, and particularly for operating such buses in fleet operations such as transit, scheduled highway, and charter services and operations.

In various aspects the disclosure may be applied with particular advantage to equipment and processes used in the operations of transit, charter, and other fleet and/or passenger bus operations, including for example bus transport (e.g. public transit), scheduled or chartered coach transport, school transport, private hire and tourism services. By, for example, eliminating the need for special-purpose chargers 22 (FIG. 1), systems and methods according to the invention can provide significant improvements in, for example, the cost, efficiency, safety, flexibility, and ease of operations for passenger buses employing electric motors and equipment in primary vehicle propulsion, including expenditures for acquiring, using, and maintaining equipment and real estate such as bus terminals, depots, and/or stations.

Further details of these and other aspects of the subject matter of this application will be apparent from the detailed description and drawings included below.

### DESCRIPTION OF THE DRAWINGS

Reference is now made to the accompanying drawings, in which:

FIG. 1 is a schematic representation of a passenger bus connected to an off-board charger according to the prior art;

FIG. 2 is a schematic representation of a passenger bus having an electrical system including an on-board charger;

FIGS. 3 and 4 are schematic representations of a passenger bus such as that of FIG. 2, showing more detailed representations of the electrical system;

FIG. 5 is a schematic representation of a portion of an electrical system such as that of FIG. 2 showing, a more detailed representation of an on-board charger; and

FIG. 6 shows a flowchart of a method of charging an electrical energy storage device on-board the passenger bus, such as that of FIG. 2.

### DESCRIPTION OF EMBODIMENTS

Aspects of various embodiments are described through reference to the drawings.

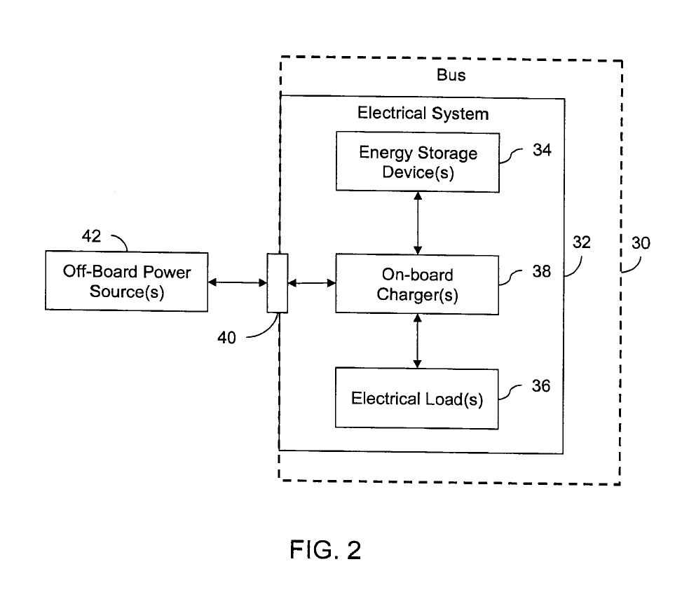

FIG. 2 shows an exemplary schematic representation of passenger bus 30 including electrical system(s) 32. As will be understood by those skilled in the relevant arts, bus 30 may also include other systems/components such as, for example, wheels, a suspension, a ventilation system, a steering system, a braking systems, a passenger cabin including seats, etc., which are not specifically shown. Electrical system(s) 32 may include electrical energy storage device(s) 34, electrical load(s) 36 and on-board charger(s) 38. Bus 30 may also comprise interface(s) 40 for coupling with and receiving electrical power from off-board power source(s) 42 during charging of energy storage device(s) 34. Interface(s) 40 may, for example, include one or more selectively releasable connectors, such as standard or specially-configured friction or interference-fit plugs, or other preferably releasbly fastened couplings for mating with corresponding (e.g. male/female) connectors at a charging station for establishing electrical communication between electrical system(s) 32 and off-board power source(s) 42.

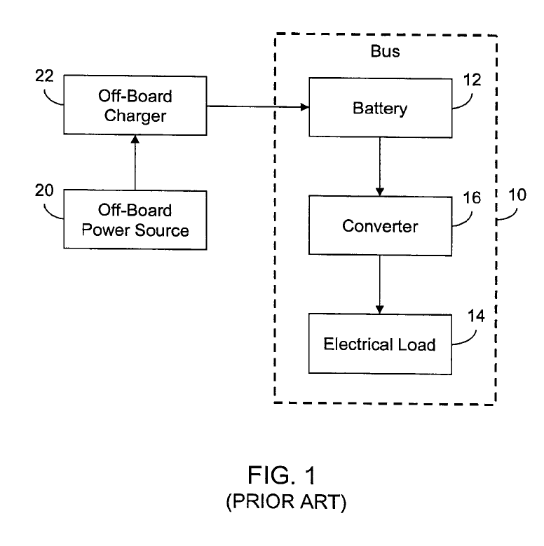

As explained further below, on-board charger(s) 38 may be configured to convert electrical power received from off-board source(s) 42 to form(s) suitable for charging energy storage device(s) 34 and also configured to convert electrical power from energy storage device(s) 34 to a form suitable for powering electrical load(s) 36. Hence, an on-board charger 38 may function as a bi-directional power converter and, depending on the capabilities of on-board charger(s) 38, may serve as an alternative to (e.g. partially or wholly replace the need for) off-board charger 22 shown in FIG. 1.

Electrical loads 36 can comprise any wholly or partially electrically-powered vehicle systems or components, including, as particular examples, one or more electric or hybrid traction motors. As further mentioned elsewhere in this description, electrical loads can also comprise vehicle interior heating, airconditioning, and ventilation systems, interior and exterior lighting, and various controls, etc., which are sometimes referred to as auxiliary loads.

Among the many significant advantages offered by systems and processes according to the disclosure is that existing buses and bus electrical systems, and designs for such buses and systems, may be adapted for charging in accordance with the disclosure. Many such adaptations or conversions may be accomplished at relatively low cost, using components such as converters, switches, and controllers (including suitably-configured software) already present on the buses and/or within the designs, and/or by substituting or adding new or replacement components.

For example, buses comprising one-directional converters may be upgraded to comprise bi-directional converters of sufficient current and voltage capacity. Buses comprising bi-directional converters and automatic controllers may be modified for on-board charging by, for example, suitable software and/or hardware modifications adapted to cause the converters to act as chargers of energy storage device(s) 34.

Passenger buses 30 suitable for use in implementing the invention may include any road vehicle(s) designed to carry a relatively large number of passengers. Typically, a bus 30 is a relatively large road vehicle having a long body and equipped with seats or benches for passengers, and operated as part of a scheduled or charter service. For example, a bus 30 may have a seating capacity of 10 to 100 but vehicles to which the teachings of the present disclosure can be applied are not necessarily limited to such seating capacity. Bus 30 may, for example, include a single-decker rigid bus, a double-decker bus, an articulated bus, a midibus, a minibus, a transit bus, a school bus and a coach used for longer distance services. Bus 30 may also be used for scheduled bus transport (e.g. public transit), scheduled or chartered coach transport, school transport, private hire and tourism. Bus 30 may also be used as a promotional bus for political campaigns and/or may be privately operated for a wide range of purposes. Passenger capacity may be increased to any desired limit(s) through, for example, the use of one or more cars or coaches mechanically connected to drive and/or control portions of the bus by articulated or other suitable joints.

The teachings of the present disclosure are applicable to ails types of buses incorporating chargeable electric systems, including all-electric and all forms of hybrid buses; and may further be applicable to other electric and hybrid vehicles, including but not limited to electric fork lift trucks, electric cars and trucks, electric automatic guided vehicles, etc., and particularly those operated in fleets.

Passenger bus 30 may be an electric or hybrid electric “plug-in” type vehicle and therefore, energy storage device(s) 34 may be used to store electrical energy used to propel bus 30 and power other types of loads on-board or off-board bus 30. For example, energy storage device(s) 34 may be rechargeable and may include one or more rechargeable batteries such as lithium-ion batteries, lithium-titanate batteries, supercapacitors, ultracapacitors and/or other types of rechargeable electrical energy storage devices.

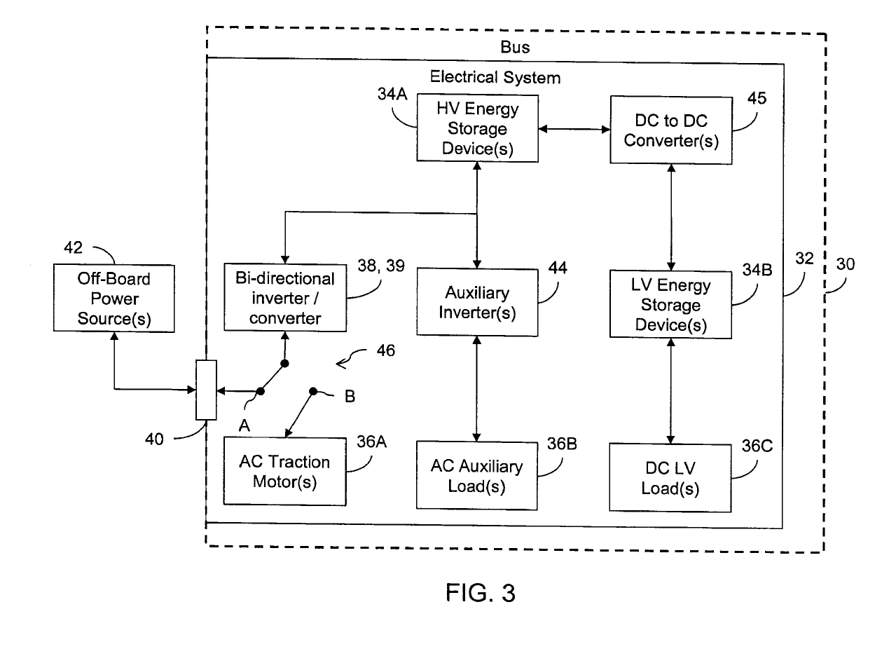

FIG. 3 shows an exemplary schematic representation of a bus 30 with a more detailed representation of electrical system(s) 32. For example, electrical system(s) 32 may include different types of electrical energy storage device(s) 34 such as high-voltage (HV) storage device(s) 34A and low-voltage (LV) storage device(s) 34B for powering different types of loads 36 (e.g. 36A, 36B and 36C). In the context of the present disclosure, HV may be defined as being greater than about 50 volts AC (alternating current) or DC (direct current) and LV may be defined as being less than about 50 volts AC or DC. HV storage device(s) 34A may be used to power a propulsion system including AC traction motor(s) 36A for propelling bus 30. HV storage device(s) 34A may also be used to power AC auxiliary load(s) 36B such as combustion engine starters, etc. LV storage device(s) 34B may be used to power DC LV load(s) 36C, such as cabin heating and air conditioning ventilation systems, interior and exterior lighting, solenoids, etc.

The powering of AC traction motor(s) 36A using HV storage device(s) 34A may be accomplished via on-board charger(s) 38, which may have bi-directional power conversion capabilities (explained in more detail below) for converting power from HV storage device(s) 34A to form(s) suitable for powering AC traction motor(s) 36A (and hence operate as converter(s) 39). When HV storage device(s) 34A has/have been at least partially depleted, bus 30 (e.g. “plug-in” type) may be brought to a charging station and be connected to off-board power source(s) 42 that can, via on-board charger(s) 38, replenish HV storage device(s) 34A to a desired level, such as a complete or partial charge state.

Traction motor(s) 36A can include one or more single or poly-phase (e.g. three-phase) AC motors. Accordingly, on-board charger(s) 38 may be configured to convert DC power from HV storage device(s) 34A to poly-phase AC power suitable for powering traction motor(s) 36A. Hence, one or more inverters 39 may function as on-board charger(s) 38. Similarly, off-board power source(s) 42 may also supply single or poly-phase (e.g. three-phase) AC power. Accordingly, inverter(s) 39 may be configured to convert poly-phase AC power from off-board power source(s) 42 to DC power for charging HV storage device(s) 34A. Hence, on-board inverters-converters 39/charger(s) 38 may also function as one or more rectifiers.

The powering of AC auxiliary load(s) 36B may be accomplished using auxiliary power conversion equipment such as auxiliary inverter(s) 44. Auxiliary inverter(s) 44 may be configured to convert DC power from HV storage device(s) 34A to AC power (e.g. including single phase and/or poly-phase) suitable for powering the AC auxiliary load(s) 36B. For example, auxiliary inverter(s) 44 may include one or more three-phase bridges. AC Auxiliary load(s) 36B may include other devices/systems on-board bus 30 such as, for example the HVAC (Heating, Ventilating and Air conditioning), air compressor and power steering systems and/or other accessories on bus 30.

The powering of DC LV load(s) 36C may be accomplished using LV storage device(s) 34B. LV storage device(s) 34B may optionally be coupled to HV storage device(s) 34A via DC to DC converter(s) 45 and accordingly receive power from HV storage device(s) 34A. For example, DC to DC converter(s) 45 may convert DC power from HV storage device(s) 34A to a float voltage used to maintain charge in the LV storage device(s) 34B. Alternatively, DC to DC converter(s) 45 may be used to directly power DC LV load(s) 36C and controls.

As shown in the exemplary configuration of FIG. 3, transfer switch(es) 46 may be provided between AC traction motor(s) 36 and on-board charger(s) 38, where each of which may typically operate at higher current and voltage levels than AC auxiliary load(s) 36B. Transfer switch(es) 46 may be manually operated or may include one or more electrically-controlled contactor(s). Transfer switch(es) 46 may be actuatable between two or more positions (e.g. A and B) to connect and disconnect off-board power source(s) 42 and AC traction motor(s) 36A to/from the AC side of on-board charger(s) 38. In position A (e.g. charging mode) as shown in FIG. 3, transfer switch(es) 46, may cause off-board power source(s) 42 to be connected to on-board charger(s) 38 while AC traction motor(s) may be disconnected from the on-board charger(s) 38. In position B (e.g. propulsion mode), transfer switch(es) 46 may cause AC traction motor(s) 36A to be connected to on-board charger(s) 38 while off-board power source(s) 42 may be disconnected from on-board charger(s) 38. As understood by one skilled in the relevant arts, additional components and switches may be used for the operation of AC traction motor(s) 36A.

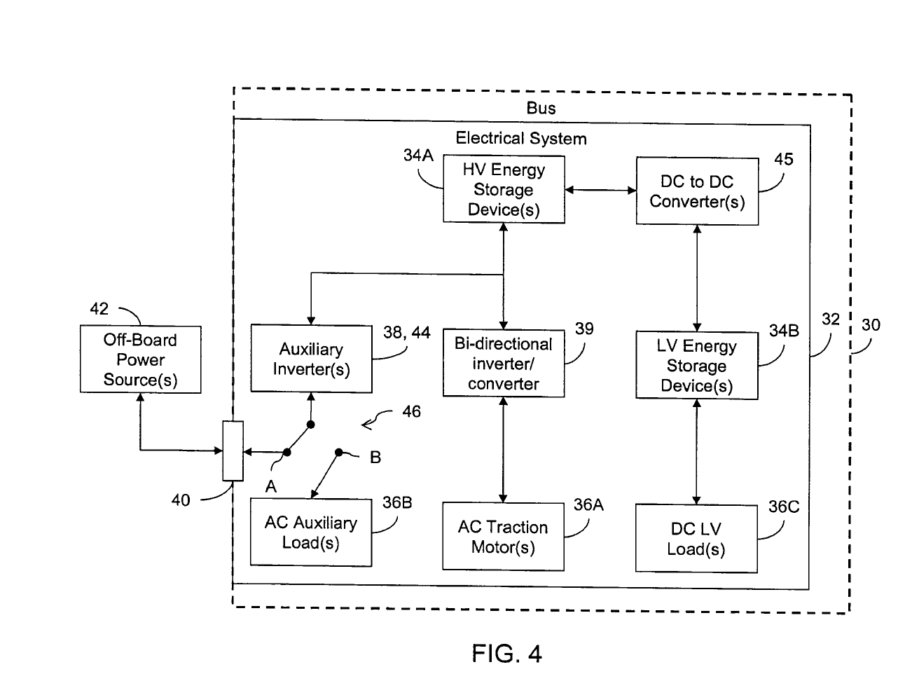

FIG. 4 shows an exemplary schematic representation of a bus 30 with a more detailed representation of electrical system(s) 32. The embodiment shown in FIG. 4 represents an alternative configuration to that shown in FIG. 3. As will be understood by those skilled in the relevant arts, in some circumstances arrangements such as that shown in FIG. 4, in which auxiliary inverter(s) 44 are configured to act as on-board charger(s) 38, may be preferred to the arrangements shown in FIG. 3. For example, in some circumstances the arrangement shown in FIG. 4 may offer safety advantages in case of certain modes of failure or malfunction in switch 46.

As previously suggested, a wide variety of configurations are suitable for use in implementing the invention, a large number of which may be realized using existing equipment on existing buses, built according to prior art design principles.

In the embodiment of FIG. 4, for example, electrical system 32 may be configured such that transfer switch(es) 46 cause off-board power source(s) 42 to selectively deliver power to auxiliary inverter(s) 44, which can thereby act as charger(s) 38, instead of (or in addition to) bi-directional inverter/converter(s) 39, which can serve auxiliary loads 36B such as air conditioning systems, etc. Auxiliary inverter(s) 44 may be embodied as bi-directional inverter(s)/converters, suitable controlled by, for example, suitably adapted controllers executing suitably configured software instruction sets. A particular advantage of the configuration shown in FIG. 4 is that the off-board power source 42 may optionally be connected simultaneously to both auxiliary inverter 44/charger 38 and to AC auxiliary loads 36B, thus simulanteously charging HV energy storage 34A and operating auxiliary loads 36B such as an air conditioning system.

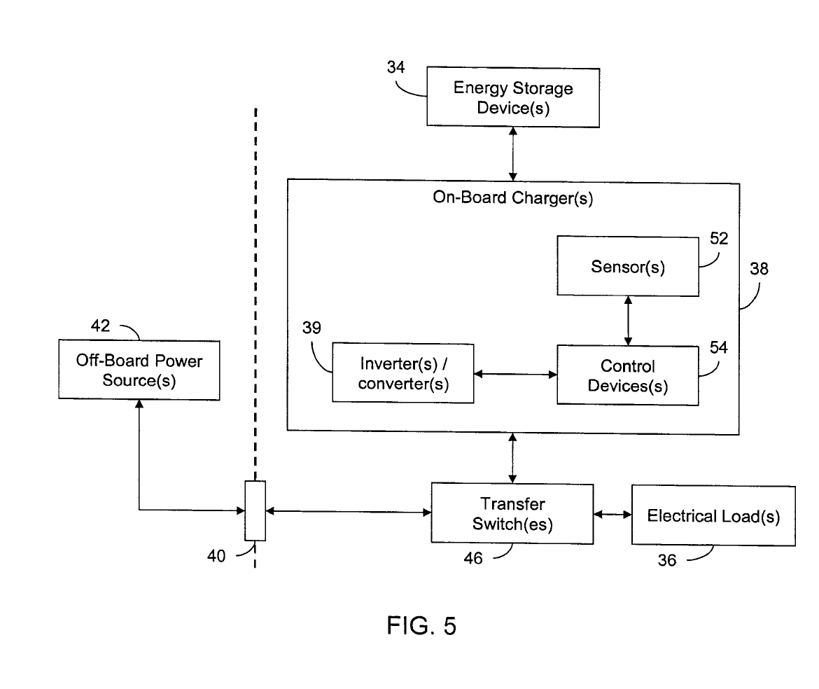

FIG. 5 shows an exemplary schematic representation of on-board charger(s) 38 suitable for use in implementing the invention. As shown, on-board charger(s) 38 may comprise one or more inverters/converters 39, which may be bi-directional; sensor(s) 52; and control device(s) 54. For example, converter(s) 39 may comprise a plurality of switches (not shown) such as insulated gate bipolar transistors (IGBTs), metal oxide semiconductor field effect transistors (MOSFETs), bipolar junction transistors (BJTs), metal oxide semiconductor controlled thyristors (MCTs) and/or other types of switching elements suitable for power conversion applications and capable of handling currents in propulsion systems of electric buses. An example of a bi-direction converter/inverter suitable for use in implementing the invention in a transit or scheduled-service application is the Seimens ELF A2 Traction Inverter.

Sensor(s) 52 may include one or more sensors for monitoring the charging of energy storage device(s) 34 (e.g. HV storage device(s) 34A). Accordingly, output from sensor(s) 52 may, for example, be representative of a charging state and/or a level of charge of energy storage device(s) 34 and may be used by control device(s) 54 to control a charging current delivered to energy storage device(s) 34. Sensor(s) 52 may, for example, include one or more voltage sensors for monitoring energy storage device(s) 34 (e.g. 34A, 34B) during charging. Sensor(s) 52, may also include one or more current sensors for monitoring the current coming from or being delivered to energy storage device(s) 34. Control device(s) 54, may also communicate with other devices and sensors outside of the charger 38, such as for example energy storage device(s) 34 where temperature, state-of-charge and health may be monitored, loads 36 and transfer switch(es) 46 where for example switch position may be monitored and/or controlled using suitably-configured switching equipment.

Control device(s) 54 may be configured to control the overall operation of on-board charger(s) 38 including the outputs of on-board charger(s) 38 during the charging mode and the propulsion mode of operation. Control device(s) 54 may be configured to make decisions regarding the control of on-board charger(s) 38. For example, control device(s) 54 may be configured to control the actuation of switches in three-phase bridge(s) 48. Control device(s) 54 may also be configured to control charging of energy storage device(s) 34 according to specific charging protocols depending on the size and type of energy storage device(s) 34 being charged. Accordingly, control device(s) 42 may have data processing capabilities and may include one or more data processors, microcontrollers or other suitably programmed or programmable logic circuits (not shown), adapted to execute suitably-configured non-transient coded instruction sets, including for example software- and/or firmware encoded control programs. Control device(s) 54 may also comprise memory(ies) (not shown) including any storage means (e.g. devices) suitable for retrievably storing machine-readable instructions executable by any processor(s) and/or logic circuit(s) in control device(s) 54.

As mentioned above, on-board charger(s) 38 may serve multiple functions by being configured or configurable in multiple modes. While configured in a propulsion mode, for example, on-board charger(s) 38 may be connected to electrical load(s) 36 (e.g. AC traction motor(s) 36A) via transfer switch(es) 46 and convert DC power from energy storage device(s) 34 to three-phase AC power suitable for powering traction motor(s) 36A. In this mode of operation, three-phase bridge(s) 48 of on-board charger(s) 38 may operate as an inverter. During a charging mode, on-board charger(s) 38 may be connected to off-board power source(s) 42 via transfer switch(es) 46 and convert three-phase AC power from off-board power source(s) 42 to DC power for charging energy storage device(s) 34. In this mode of operation, three-phase bridge(s) 48 of on-board charger(s) 38 may operate as a rectifier. Hence, on-board charger(s) 38 may function as a bi-directional power converter so that three-phase bridge(s) 48 and other components may be used during charging of energy storage device(s) 34 and also during powering of load(s) 36.

Charger(s) 38 may be configured, via suitably-adapted hardware and/or software switches, etc., to function as, for example, one-way inverters/converters, bi-directional inverters/converters, and/or rectifiers.

HV storage device(s) 34A may be configured to provide any desired and/or otherwise suitable voltage and/or current levels. For example, an HV battery may be configured to hold a 650-volt charge at currents suitable for powering AC traction motor(s) 36A. Accordingly, during a propulsion mode, on-board charger(s) 38 may function as an inverter where DC power from HV storage device(s) 34A may be converted to three-phase AC power via three-phase bridge(s) 48 under the control of control device(s) 54, and, delivered to AC traction motor(s) 36A.

In order to charge energy storage device(s) 34 (e.g. 34A, 34B), regulated DC power may need to be delivered to energy storage device(s) 34 in a controlled manner that is compatible with the characteristics of energy storage device(s) 34. While power from off-board power source(s) 42 may be in a form suitable for power distribution over long distances (e.g. three-phase AC power from a utility grid), this form may not be suitable for charging energy storage device(s) 34. Accordingly, on-board charger(s) 38 may be used to convert power from off-board power source(s) 42 to a suitable form.

Power from commercial utility grids may be of differing types, voltages and frequencies depending on the location (i.e. country, region) and conditions. Accordingly, on-board charger(s) 38 may be configured to accept power from off-board power source(s) 42 in different forms, and modified as needed in order to properly charge storage device(s) 34, e.g. through the use of filters, transformers, capacitors, etc., as needed to properly couple off-board source(s) to storage device(s) 34 for effective charging. For example, in such applications where the voltage of the power received from off-board power source(s) 42 is not sufficiently high for proper charging, transformer(s) 50 may be used to step-up the voltage prior to rectification using three-phase bridge(s) 48. Alternatively, too-high voltage may be stepped down as needed.

As understood by those skilled in the relevant arts, on-board charger(s) 38 could be configured to accommodate electrical power from sources of other types (e.g. AC, DC, single-phase or poly-phase) and voltages and perform the conversion necessary for charging energy storage device(s) 34. For example, on-board charger(s) 38 could be configured to accommodate single-phase AC power instead of or in addition to poly-phase AC power.

On-board charger(s) 38 may be used to convert utility power (e.g. three-phase AC) to regulated DC power that can be used to charge energy storage device(s) 34 in a controlled manner compatible with the characteristics of energy storage device(s) 34. The specific charging protocol to be followed by on-board charger(s) 38 may depend on the size and type of storage device(s) (e.g. battery) being charged. For example, some battery types may have high tolerance for overcharging and may be charged by connection to a constant voltage source or a constant current source. Alternatively, other battery types may not withstand long, high-rate over-charging. Accordingly, control device(s) 54 may be used to adjust the charging current based on output(s) from monitoring sensor(s) 52 and automatically terminate charging when the charge of energy storage device(s) 34 has been sufficiently replenished. For example, control device(s) 54 may further include a variable resistance to control current flow to energy storage device(s) 34 during charging in response to one or more signals received from monitoring sensor(s) 52.

Among other advantages provided by systems and processes according to the disclosure, it may be seen that the ability of on-board charger(s) 38 to enable charging of buses using electricity provided at the wall of stations, depots, terminals, and other facilities or locations, or at other plug-in stations can eliminate the need for acquiring, operating, maintaining, and securing special-purpose chargers, with resulting significant cost, labor, and real estate savings. As will be apparent to those skilled in the relevant arts, that can have significant effects on the efficiency and other factors of transit, charter, and other passenger bus operations.

The bi-directional power conversion capabilities of on-board charger(s) 38 may also permit recapture of energy during regenerative braking when slowing down bus 30. For example, regenerative braking may be initiated when the driver of bus 30 depresses a brake pedal and causes a braking signal to be provided to the propulsion system. In such an embodiment the initial movement of the brake pedal may or may not initially provide any service air for air brakes but may instead or in addition engage a regenerative braking mode where load(s) 36 (e.g. traction motor(s) 36A) may function as generator(s) and supply power for charging energy storage device(s) 34.

During operation in regenerative braking mode, the propulsion system may allow traction motor(s) 36A to function as three-phase alternator(s) driven by a drive axle system due to the vehicle's movement (i.e. inertia). The three-phase AC power output from traction motor(s) 36A while in braking mode may be directed to the AC side of on-board charger(s) 38. On-board charger(s) 38 may in turn convert this three-phase AC power into DC power at its DC side. This converted DC power may in turn be delivered to energy storage device(s) 34 to replenish its charge and also be delivered to other load(s) 36. The electrical load provided by the energy storage device(s) 34 and other loads(s) 36 (e.g. 36B and 36C) to traction motor(s) 36A may cause traction motor(s) 36A draw mechanical power from the drive axle system and thus slow bus 30.

In the same and/or other embodiments, a zero-accelerator signal may be generated when the vehicle's accelerator is not engaged, and can be used to initiate power regeneration. In general, regeneration may be activated by any suitable control strategy, including for example either or both of zero-acceleration signals and/or brake pedal requests.

Bus 30 and other types of vehicles comprising electrical system(s) 32 and/or on-board charger(s) 38 as described herein may be made by means of new construction and/or by retrofitting existing vehicles. Retrofitting of existing vehicles to implement the invention may involve the replacement and/or upgrading of existing components, such as inverters, switches, rectifiers, filters, and transformers; the addition of switch(es) 46 and/or adaptation of existing switches to accomplish the functions described herein of switch(es) 46; and in some cases the modification or adaptation of controllers and control processes to operate switches 46 and converters 38, 39, to operate as chargers 44.

During operation, bus 30 may function as an electric or hybrid electric bus whereby energy storage device(s) 34 may be used to power traction motor(s) 36A and other load(s) 36 in order to propel bus 30 and also power various systems and accessories of bus 30 during transit. In the case of a completely electric bus, the range of bus 30 may be limited by the capacity of energy storage device(s) 34. In any event, when the charge(s) of energy storage device(s) 34 of bus 30 become(s) at least partially depleted or reach(es) a predetermined minimum level, it may be desirable to replenish the charge of energy storage device(s) 34. The charging of energy storage device(s) 34 may be done at a charging station comprising one or more connections to off-board power source(s) 42. As mentioned above, since bus 30 comprises on-board charger(s) 38, it may not be necessary that charging station comprise an off-board charger 22 as shown in FIG. 1.

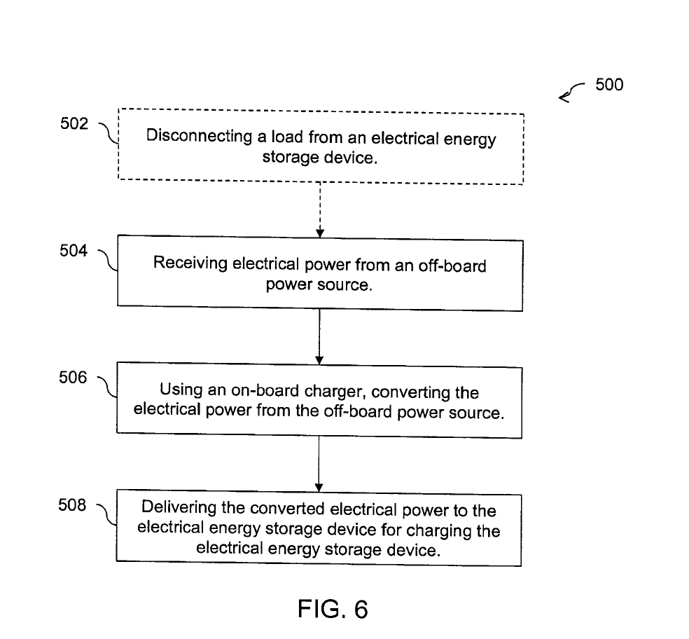

FIG. 6 shows a flowchart of a method 500 that may be used to charge energy storage device(s) 34 on-board passenger bus 30. The method may, for example, comprise: optionally disconnecting one or more load(s) 36 from the energy storage device(s) 34 (see step 502); receiving electrical power from off-board power source(s) 42 (see step 504); using on-board charger(s) 38, converting the electrical power from off-board source(s) 42 to a form suitable for charging electrical energy storage device(s) 34 (see step 506); and delivering the converted electrical power to electrical energy storage device(s) 34 (see step 508).

The disconnection of load(s) 36 from energy storage device(s) 34 (step 502) may be done using transfer switch(es) 46. It is envisioned that, depending on the specific application and type of load(s) 36, this step may not be necessary and that in some instances at least some of load(s) 36 could remain connected to energy storage device(s) 34 and receive power even during charging of energy storage device(s) 34.

As explained above, the conversion electrical power from off-board source(s) 42 (step 506) and the delivery of converted electrical power to energy storage device(s) 34 (step 508) may be conducted using on-board charger(s) 38 so that regulated DC power is delivered in a controlled manner compatible with the characteristics of energy storage device(s) 34.

The above description is meant to be exemplary only, and one skilled in the art will recognize that changes may be made to the embodiments described without departing from the scope of the invention disclosed. For example, the steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified. The present disclosure may be embodied in other specific forms without departing from the subject matter of the claims. The present disclosure is also intended to cover and embrace all suitable changes in technology. Still other modifications which fall within the scope of the present invention will be apparent to those skilled in the art, in light of a review of this disclosure, and such modifications are intended to fall within the appended claims.

1. A passenger bus comprising:
an electrical energy storage device for supplying electrical power to an electrical load;
an interface for receiving electrical power from an off-board source; and
an on-board charger electrically coupled to the electrical energy storage device, the on-board charger being configured to convert electrical power received from the off-board source via the interface to a form suitable for charging the energy storage device.

2. The passenger bus as defined in claim 1, wherein the charger comprises a bi-directional power converter.

3. The passenger bus as defined in claim 1, wherein the electrical load includes a propulsion system of the passenger bus.

4. The passenger bus as defined in claim 3, wherein the charger is configured to convert electrical power from the energy storage device to a form suitable for powering the propulsion system.

5. The passenger bus as defined in claim 1, comprising a transfer switch for establishing electrical communication between the on-board charger and either one of the interface and a traction motor.

6. The passenger bus as defined in claim 1, wherein the on-board charger comprises a transformer.

7. The passenger bus as defined in claim 1, wherein the charger is configured to convert three-phase AC electrical power from the off-board electrical source to regulated DC electrical power for charging the energy storage device.

8. The passenger bus as defined in claim 1, wherein the charger is configured to convert DC electrical power from the electrical storage device to three-phase AC electrical power for driving a traction motor of the passenger bus.

9. The passenger bus as defined in claim 1, wherein the on-board charger is configured to output DC power regulated in accordance with a charging protocol of the electrical energy storage device.

10. An electrical system for a passenger bus, the system comprising:
an electrical energy storage device for supplying electrical power to an electrical load;
an interface for coupling to an off-board source of electrical power; and
an on-board charger electrically coupled to the electrical energy storage device, the on-board charger being configured to convert electrical power received from the off-board source via the interface to a form suitable for charging the energy storage device.

11. The passenger bus as defined in claim 10, wherein the charger is configured to convert electrical power from the electrical storage device to a form suitable for powering the electrical load.

12. The electrical system as defined in claim 11, wherein the electrical load includes a traction motor.

13. The electrical system as defined in claim 12, wherein the on-board charger comprises a bi-directional power converter.

14. The electrical system as defined in claim 10, wherein the charger is configured to convert three-phase AC power from the off-board electrical source to regulated DC power for charging the electrical energy storage device.

15. A method for charging an electrical energy storage device on a passenger bus using a charger on-board the passenger bus, the method comprising:
receiving electrical power from an off-board source;
using the on-board charger, converting the electrical power from the off-board source to a form suitable for charging the electrical energy storage device; and
delivering the converted electrical power to the electrical energy storage device.

16. The method as defined in claim 15, comprising monitoring the charging of the electrical energy storage device.

17. The method as defined in claim 16, wherein the converted electrical power is DC power regulated in accordance with a charging protocol of the electrical energy storage device.

18. The method as defined in claim 17, wherein converting the electrical power from the off-board source comprises changing a voltage of the electrical power from the off-board source.

19. The method as defined in claim 15, wherein converting the electrical power from the off-board source comprises converting three-phase AC power from the off-board source to regulated DC power.

20. The method as defined in claim 15, comprising disconnecting a load from the energy storage device prior to receiving electrical power from the off-board source.
